(19) United States
(12) Patent Application Publication
(10) Pub. No.: US 2011/0086142 A1
(43) Pub. Date: Apr. 14, 2011

(54) COOKED, WHOLE GRAIN RICE IN A BOWL AND METHODS THEREOF

(76) Inventor: Taejin Song, Fullerton, CA (US)

(21) Appl. No.: 12/579,366

(22) Filed: Oct. 14, 2009

(51) Int. Cl. B65D 81/34; A23L 1/01; A23L 1/168

(52) U.S. Cl. 426/113; 426/394

(57) ABSTRACT

A method for preparing a grain includes: soaking the grain utilizing a first water; draining the first water; transferring the grain into a bowl; adding a second water to the grain; heating the grain in the bowl in a first cooking; sealing the bowl; and heating the grain in the bowl in a second cooking, thereby making the grain fully cooked and shelf stable. This produces cooked, shelf stable whole grain rice in a bowl.

### BACKGROUND OF THE INVENTION

The present invention generally relates to pre-cooked food, and more specifically, to cooked, whole grain rice in a bowl.

People want to eat whole grain rice like brown rice (in contrast to white rice) in a quick and easy manner, but it takes a long time to cook at home, so people remain unsatisfied. Also, people buy cooked rice products with flavors in a pouch but again are unsatisfied with the taste and texture.

Others cook parboiled rice with oil or artificial flavors that end up with double cooking the rice, losing natural taste and texture.

As can be seen, there is a need for a pre-cooked food with good taste and texture.

### SUMMARY OF THE INVENTION

In one aspect of the present invention, a method for preparing a grain includes: soaking the grain utilizing a first water; draining the first water; transferring the grain into a bowl; adding a second water to the grain; heating the grain in the bowl in a first cooking; sealing the bowl; and heating the grain in the bowl in a second cooking, thereby preparing the grain.

In another aspect of the present invention, a food product includes: a bowl; and a quantity of grain, said grain having been rinsed, soaked, drained, transferred to the bowl, cooked in water a first time, sealed, and then cooked a second time at a temperature high enough to sterilize the grain

These and other features, aspects and advantages of the present invention will become better understood with reference to the following drawings, description and claims.

### BRIEF DESCRIPTION OF THE DRAWINGS

FIG. 1 depicts a flowchart of an embodiment of the present invention; and

FIG. 2 is a perspective view of an embodiment of the present invention; and

FIG. 3 is a side view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides fully cooked whole grain rice in a bowl for individual consumption in a quick and easy way.

An embodiment of the present invention cooks whole grain rice so that it is easy to chew and digest, keeping natural texture and taste. Embodiments may be shelf stable, with no preservatives, no chemicals, no artificial flavors, and may be ready in 90 seconds—heat and eat. In an embodiment, unprocessed (natural) whole grain rice is cooked in an individual bowl to keep natural taste and texture. There is one, serial 2-step cooking process to fully cook whole grain rice.

An embodiment may include the following steps: soaking rice in a tank filled with water (to reach a desirable level of moisture in the rice); drain water; transfer soaked rice to be dispensed into each and every bowl (rice dispensing); add cooking water (specific amount); first cook at a temperature and time (to reach a specific desired level of moisture in rice); seal with lid film on bowl; second cook and sterilization at a specific temperature, pressure and time; and cooling.

In another embodiment, rinsed and dried rice may be used to remove the effects of the rinsing process.

An embodiment may include the following activities: rinse remove foreign material); soak (make rice softer); drain water (drain excessive water); rice dispensing into each bowl (to cook individually, with a size for an individual serving of approximately 2 to 5 oz.); add cooking water (to boil the rice in a bowl); first cooking (at a certain temperature and time); seal with lid film on bowls (ready for second cook and sterilization); second cook and sterilization (at a certain temp, pressure and time to cook rice fully and make rice bowl shelf stable); and cooling (for handling).

In an embodiment, rice is cooked in an individual bowl, not in bulk. There is one serial 2-step cooking process to make whole grain rice fully cooked and to make whole grain rice very soft, easy to chew and digest. At the first cook, the rice is cooked only to a certain degree at a certain temperature and time. This leaves some of ‘cooking water’ not absorbed into rice. Cook the rice up to 100% absorption of cooking water in the second cooking process, at 230 F to 248 F for approximately 25 to 35 minutes. At this second cooking, sterilization is done at the same time to make the product shelf stable.

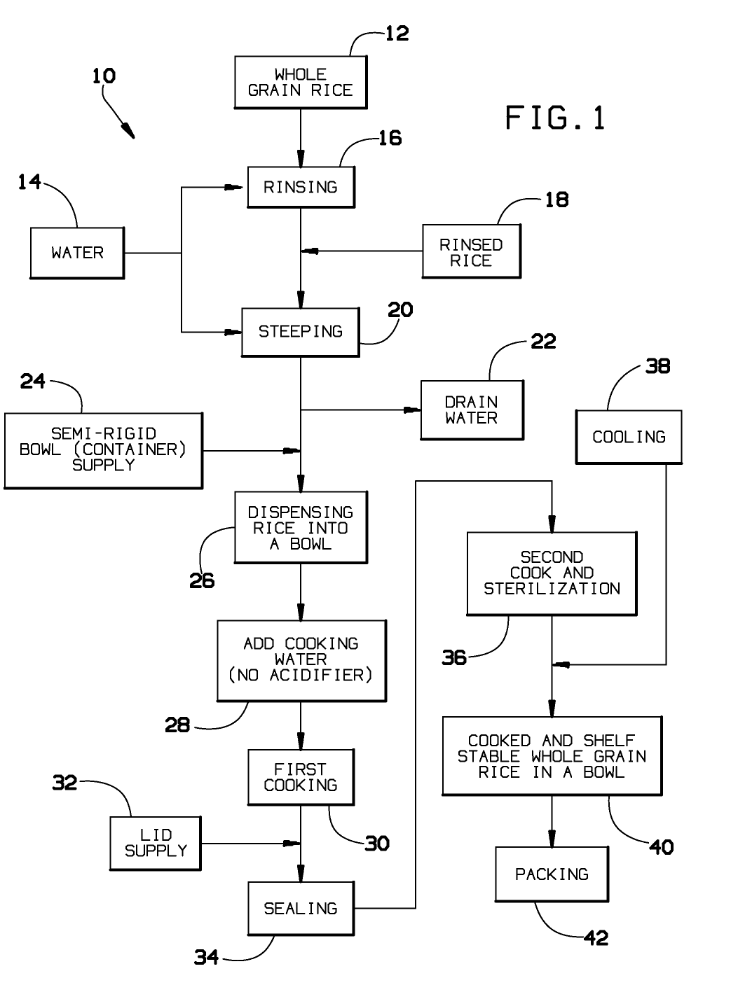

As depicted in the flowchart of FIG. 1, an embodiment of the present invention may include the following. Whole grain rice 12 is provided. Water 14 is added. The rice is rinsed 16, producing rinsed rice 18, which is then steeped 20 in water. Drain water 22 is removed. A semi-rigid bowl or other container is supplied 24, and the rice is dispensed into the bowl 26. Cooking water is added 28. No acidifier is needed. The rice is cooked a first time 30. In an embodiment, this may be performed at a temperature from about 210 degrees to 212 degrees F. (99 C to 100 C), for about 17 to 20 minutes. In an embodiment, the water is no hotter than boiling. A lid is provided 32 and the product is sealed 34. The rice is cooked a second time 36 which helps generally sterilize or sanitize the rice. In an embodiment, this may be performed at about 248 degrees F. (120 C) for about 30 to 35 minutes. In embodiments, the second cooking may be performed at from 230 F to 248 F.

The product is cooled 38. The cooked and shelf-stable whole grain rice in a bowl 40 is packed 42. In other embodiments, grains such as quinoa, barley, or beans are utilized instead of rice.

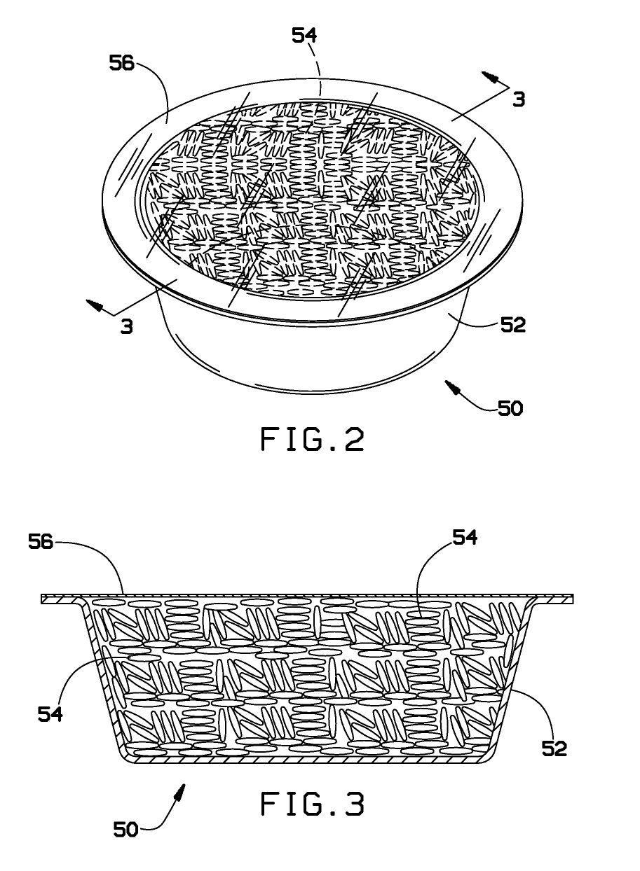

FIG. 2 depicts an embodiment of a finished food product 50 according to the present invention. This includes the bowl 52, the rice 54 or other grain, and a lid film 56. FIG. 3 is a side view of the embodiment of FIG. 2 taken along line 3.

An embodiment of the present invention uses no acidifier, cooking whole grains with no pretreatment. It employs two cooking processes, at different temperatures.

Embodiments may be performed with custom made or other automatic processing equipment.

Embodiments may be used differently (for example, at different temperatures and times) to cook different whole grains like quinoa, barley, beans etc. Embodiments may produce fully cooked whole grain(s) in a bowl for individual serving. The possible whole grains may include brown rice, sweet brown rice, wild rice, quinoa, barley, and beans.

It should be understood, of course, that the foregoing relates to exemplary embodiments of the invention and that modifications may be made without departing from the spirit and scope of the invention as set forth in the following claims.

We claim:

1. A method for preparing a grain, comprising:
soaking the grain utilizing a first water;
draining the first water;
transferring the grain into a bowl;
adding a second water to the grain;
heating the grain in the bowl in a first cooking;
sealing the bowl; and
heating the grain in the bowl in a second cooking, thereby preparing the grain.

2. The method of claim 1, wherein the bowl is adapted to hold an individual serving of grain, and the individual serving of the grain is transferred into the bowl.

3. The method of claim 2, wherein the individual serving of the grain weighs between two ounces and five ounces.

4. The method of claim 1, further comprising:
performing the first cooking at a first temperature between two degrees below a boiling temperature and the boiling temperature; and
performing the second cooking at a second temperature above the boiling temperature.

5. The method of claim 1, further comprising:
performing the second cooking at a sufficient temperature, length of time, and pressure to substantially sterilize the grain.

6. The method of claim 1, further comprising:
rinsing the grain utilizing a third water; and
substantially removing the third water from the grain before soaking the grain utilizing the first water.

7. The method of claim 1, wherein the grain is selected from the group consisting of: rice, quinoa, barley, and beans.

8. The method of claim 1, wherein the bowl is sealed with a lid film.

9. A food product, comprising:
a bowl; and
a quantity of grain, said grain having been rinsed, soaked, drained, transferred to the bowl, cooked in water a first time, sealed, and then cooked a second time at a temperature high enough to sterilize the grain.

10. The food of claim 9, wherein the sterilized grain is free from acidifiers.
